(19) United States
(12) Patent Application Publication
(10) Pub. No.: US 2026/0130387 A1
(43) Pub. Date: May 14, 2026

(54) METHOD FOR PREPARING COFFEE CONCENTRATE

(71) Applicants: Agro-products Processing Research Institute, Yunan Academy of Agricultural Sciences, Kunming (CN); Tengchong Tongsantai Agricultural Development Co.,Ltd., Baoshan (CN)

(72) Inventors: Hao Tian, Kunming (CN); Jiwei Zhou, Kunming (CN); Fang Yang, Kunming (CN); Hongzhu Shi, Kunming (CN); Zhen Ye, Baoshan (CN)

(21) Appl. No.: 19/226,164

(22) Filed: Jun. 3, 2025

(30) Foreign Application Priority Data
Nov. 11, 2024 (CN) 202411595298.5

(51) Int. Cl. A23F 5/26; A23F 5/28; A23F 5/48

(52) U.S. Cl. CPC A23F 5/267; A23F 5/28; A23F 5/483

(57) ABSTRACT

A method for preparing coffee concentrate is provided. The method includes: grinding coffee beans to obtain ground coffee beans, adding the ground coffee beans into water and then performing ultrasonic extraction to obtain a first mixture, and filtering the first mixture to obtain coffee extract and coffee grounds; adding the coffee grounds into ethanol solution for extraction, and then removing ethanol by vacuum concentration to obtain coffee oil; uniformly mixing the coffee oil and the coffee extract at room temperature to obtain a second mixture, and cooling and standing the second mixture to obtain a coffee oil layer and a coffee liquid layer; and concentrating the coffee liquid layer to obtain concentrated coffee liquid layer, and uniformly mixing the concentrated coffee liquid layer with the coffee oil layer to thereby obtain the coffee concentrate.

### CROSS-REFERENCE TO RELATED APPLICATION

This application claims priority to Chinese patent application No. CN 202411595298.5, filed to China National Intellectual Property Administration (CNIPA) on Nov. 11, 2024, which is herein incorporated by reference in its entirety.

### TECHNICAL FIELD

The present disclosure relates to the technical field of coffee processing, and particularly to a method for preparing coffee concentrate.

### BACKGROUND

In terms of flavor description of coffee, there are several dimensions commonly used worldwide, such as acidity, aroma, sweetness, and mellowness. The primary flavors of coffee are: fruity and floral acidity flavor dominated by fruit or floral aromas, spicy and roasted flavor dominated by resinous, thiol, and scorched aromas, and caramel-chocolate flavor dominated by caramel, nuts, chocolate, and almond notes. Floral and fruity aromas are the most cherished flavors in specialty coffees. Presently, the restoration of coffee flavors in the market primarily focuses on the recreation of the spicy and roasted flavor and the caramel-chocolate flavor. There have been no reports regarding methods to retain the floral and fruity aromas in coffee. In industry, there is no industrialized method to retain the floral and fruity aromas in products effectively.

In industry, coffee extraction includes both hot and cold extraction methods. During a hot extraction process, to increase an extraction efficiency and an extraction speed, methods such as heating and pressurization are often employed for coffee extraction. However, during a heating process, chemical reaction between compounds is difficult to control, which often leads to inconsistent flavors in coffee produced in different batches. Moreover, because substances like organic acids are prone to oxidation, the freshness of the coffee is reduced. Additionally, low-content floral and fruity aroma components are challenging to recover and restore, leading to a lower flavor fidelity in hot-extracted coffee. Compared to the hot extraction, the cold extraction performs extraction at lower temperatures, significantly retaining more floral and fruity aroma components, reducing the oxidation of acidic substances, thus maintaining the higher freshness of coffee and a softer mouthfeel with less bitterness. Coffee liquids prepared using methods such as cold extraction and ice drip extraction are highly favored domestically and internationally. However, due to a longer extraction time and lower extraction efficiency of the cold extraction, production costs are relatively higher. Furthermore, because of the low-temperature treatment of the cold extraction, substances like oils in the coffee are more complex to dissolve, and thus, the coffee liquid has a lower body.

After the coffee extraction, to reduce the cost, concentration is usually adopted, and the concentration includes thermal concentration and cold concentration. The thermal concentration can damage the thermally sensitive flavors, aromas, and nutritional components in coffee, significantly impacting product quality. There are two main ways to achieve cold concentration: membrane concentration and freeze concentration. The membrane concentration is to concentrate coffee liquid at room temperature. Still, the flavor loss of the coffee is severe, profound due to the adsorption of the membrane, especially the loss of floral and fruity aroma components, which leads to a vast difference between the flavor of coffee concentrate and the flavor of the original liquid, such that is difficult to restore the flavor of the coffee liquid. The freeze concentration can better preserve the flavor of the coffee liquid, because the freeze concentration is carried out at a lower temperature, such as about 0° C. However, the freeze concentration requires multiple rounds of concentration, with each round taking more than 20 hours, and thus the production efficiency of the freeze concentration is lower. Further, Additionally, the processing capacity of a device used for freeze concentration is not higher, and the device itself is expensive.

### SUMMARY

Based on the above, the present disclosure provides a method for preparing coffee concentrate, and the coffee concentrate prepared by the present disclosure can retain weak floral and fruity aroma components.

To achieve the above objectives, the present disclosure provides the following technical solutions.

In the first aspect, an embodiment of the present disclosure provides a method for preparing coffee concentrate, which includes the following steps:
grinding coffee beans to obtain ground coffee beans, adding the ground coffee beans into water and then performing ultrasonic extraction to obtain a first mixture, and filtering the first mixture to obtain coffee extract and coffee grounds;
adding the coffee grounds into ethanol solution for extraction, and then removing ethanol by vacuum concentration to obtain coffee oil;
uniformly mixing the coffee oil and the coffee extract at room temperature to obtain a second mixture, and cooling and standing the second mixture to obtain a coffee oil layer and a coffee liquid layer; and
concentrating the coffee liquid layer to obtain a concentrated coffee liquid layer, and uniformly mixing the concentrated coffee liquid layer with the coffee oil layer to obtain the coffee concentrate.

In some embodiments of the present disclosure, a temperature for the ultrasonic extraction is 0-30° C., a duration for the ultrasonic extraction is 10-60 minutes, and a solid-to-liquid ratio of the ground coffee beans to the water is 1:(3-10) (g:mL).

In some embodiments of the present disclosure, the ethanol solution is ethanol aqueous solution with a volume concentration of 80%-95%.

In some embodiments of the present disclosure, a temperature for the vacuum concentration is 30-60° C.

In some embodiments of the present disclosure, the cooling the second mixture includes cooling the second mixture to a temperature of 0-8° C. at a cooling rate of 3-5° C./h.

In some embodiments of the present disclosure, a duration for the standing is 8-12 hours.

In some embodiments of the present disclosure, the concentrating the coffee liquid layer to obtain a concentrated coffee liquid layer includes: filtering the coffee liquid layer using a ceramic membrane to obtain a filtered coffee liquid layer, and concentrating the filtered coffee liquid layer using a reverse osmosis membrane to obtain the concentrated coffee liquid layer with a mass concentration of 7%-30%.

In some embodiments of the present disclosure, the concentrating the coffee liquid layer to obtain a concentrated coffee liquid layer, and uniformly mixing the concentrated coffee liquid layer with the coffee oil layer to thereby obtain the coffee concentrate further includes: concentrating the coffee liquid layer to obtain the concentrated coffee liquid layer, uniformly mixing the concentrated coffee liquid layer with the coffee oil layer to obtain a third mixture, and performing degassing, nitrogen filling, and packaging on the third mixture to obtain a packaged mixture. Before the packaging, the method for preparing coffee concentrate further includes adjusting a pH value.

In some embodiments of the present disclosure, after the packaging, the method for preparing coffee concentrate further includes: performing water bath sterilization on the packaged mixture, where the water bath sterilization is performed under a temperature of 60-100° C. for a duration of 20-60 minutes to obtain the coffee concentrate.

In a second aspect, coffee concentrate is provided, and the coffee concentrate is prepared using the method for preparing coffee concentrate described above.

In a third aspect, an embodiment of the present disclosure provides a method for retaining floral aroma components in coffee concentrate, which includes the method for preparing the coffee concentrate described above.

The present disclosure has at least the following technical effects.

The method is simple, no special device is needed, the preparation time is shorter, the time and cost are saved, and large-scale industrial production is easier.

The coffee concentrate prepared by the method of the present disclosure can retain weak floral and fruity aroma components, and has higher body and good flavor.

### BRIEF DESCRIPTION OF DRAWINGS

To explain the embodiments of the present disclosure or the technical solutions in the related art more clearly, drawings needed in the embodiments will be briefly introduced below. Apparently, the drawings described below are merely some embodiments of the present disclosure, and other drawings can be obtained according to these described drawings without creative work for the skilled in the art.

FIG. 1 illustrates flavor retention conditions of coffee concentrates prepared in an embodiment 1 and a comparative example 1.

FIG. 2 illustrates flavor retention conditions of coffee concentrates prepared in the embodiment 1 and a comparative example 2.

FIG. 3 illustrates flavor retention conditions of coffee concentrates prepared in the embodiment 1 and a comparative example 3.

FIG. 4 illustrates flavor retention conditions of cold-brewed coffee original liquid prepared in a comparative example 4 and coffee concentrate prepared in a comparative example 7.

FIG. 5 illustrates flavor retention conditions of cold-brewed coffee original liquid prepared in the comparative example 4 and coffee concentrate prepared in a comparative example 6.

FIG. 6 illustrates flavor retention conditions of cold-brewed coffee original liquid prepared in the comparative example 4 and coffee concentrate prepared in a comparative example 5.

FIG. 7 illustrates flavor retention conditions of cold-brewed coffee original liquid prepared in the comparative example 4 and the coffee concentrate prepared in the embodiment 1.

FIG. 8 illustrates flavor retention conditions of cold-brewed coffee original liquid prepared in the comparative example 4 and coffee concentrate prepared in a comparative example 8.

### DETAILED DESCRIPTION OF EMBODIMENTS

Multiple exemplary embodiments of the present disclosure will now be described in detail, and this detailed description should not be considered as a limitation of the present disclosure, but should be understood as a more detailed description of certain aspects, characteristics and embodiments of the present disclosure.

It should be understood that the terminology described in the present disclosure is only for describing specific embodiments and is not used to limit the present disclosure. In addition, for a numerical range in the present disclosure, it should be understood that each intermediate value between an upper limit and a lower limit of the numerical range is also specifically disclosed. Intermediate values within any stated value or stated range, as well as each smaller range between any other stated value or an intermediate value within the indicated range, are also included in the present disclosure. Upper and lower limits of these smaller ranges can be independently included or excluded from the range.

Unless otherwise specified, all technical and scientific terms used herein have the same meaning as commonly understood by one of ordinary skill in the art to which this present disclosure relates. Although the present disclosure only describes the preferred methods and materials, any methods and materials similar or equivalent to those described herein can also be used in the practice or testing of the present disclosure.

It is apparent to those skilled in the art that many improvements and changes can be made to the specific embodiments of the present disclosure without departing from the scope or spirit of the present disclosure. Other embodiments will be apparent to the skilled person from the description of the present disclosure. The description and embodiments of that present disclosure are exemplary only.

The terms “contain”, “including”, “having” and “containing” used in the present disclosure are all open-ended terms, which mean “including but not limited to”.

The terms “room temperature” and “normal temperature” in the present disclosure mean a temperature in a range of 20-30° C., unless otherwise specified.

In one aspect, an embodiment of the present disclosure provides a method for preparing coffee concentrate, which includes the following steps 1-6.

In step 1, coffee beans are ground to obtain ground coffee beans with a particle size of 10-80 mesh.

In step 2, the ground coffee beans are added to water according to a solid-to-liquid ratio of 1:10-1:3 (in units of g:mL), ultrasonic extraction is then performed for 10-60 minutes at a water temperature of 0-30° C. (i.e., a temperature of the water is in a range of 0-30° C.) to obtain a first mixture, and finally, the first mixture is filtered to separate coffee extract from coffee grounds. In step 2, the duration for the ultrasonic extraction is 10-60 minutes. The temperature for the ultrasonic extraction is 0-30° C., to ensure that an extraction process is carried out at a lower temperature, to prevent chemical reactions between compounds during a heating process to cause the taste change, and also to avoid volatile elements from volatilization loss caused by heating. In addition, ultrasound improves extraction efficiency through cavitation, and the extraction time can be reduced from approximately 12 hours (for soaking the ground coffee beans) to within 60 minutes. The present disclosure has no special requirement for an ultrasonic power, and an ultrasonic power commonly used in the field can be adopted.

In step 3, ethanol with a volume concentration of 80%-95% is added to the coffee grounds for extraction according to a solid-to-liquid ratio of 1:6-1:3 (in units of g:mL), and a duration for the extraction is in a range of 5-60 minutes. Then, a concentrating process under reduced pressure is performed at 30-60° C. to remove ethanol to obtain coffee oil. In step 3, through the extraction of coffee oil and subsequent mixing of the coffee oil with coffee extract, the body and aftertaste of cold brew coffee are improved.

The applicant also attempts to extract the coffee oil by other organic solvents, such as ethyl acetate and petroleum ether, or by using a supercritical CO₂ extraction method; however, these organic solvents, such as the ethyl acetate and the petroleum ether, will cause residual taste, which will affect the flavor of the coffee concentrate, and the supercritical CO₂ extraction method requires higher standards for equipment and involves a more significant investment.

In step 4, at normal temperature, the coffee oil is added to the coffee extract and uniformly mixed to obtain a second mixture. Then, the temperature of the second mixture is slowly lowered at a cooling rate of 3-5° C./h to reach a temperature in a range of 0-8° C. However, the above process should not allow the second mixture to freeze. Then, the second mixture is left to stand overnight until the coffee oil and extract are fully layered to obtain a coffee oil layer and a coffee liquid layer. In step 4, firstly, because the mixing process is carried out at the normal temperature, and the temperature is lower, volatilization loss of volatile elements is reduced. Secondly, the coffee oil is added to the extract and mixed uniformly. Because the coffee oil is insoluble in water, the coffee oil and the coffee extract must be thoroughly mixed to make the coffee oil be in full contact with aroma components in the coffee extract. Aroma components are generally volatile fat-soluble components and are easily dissolved in the coffee oil, thereby preventing the volatilization of the aroma components. Thirdly, the second mixture is cooled down slowly with a cooling rate of 3-5° C./h. It should be noted that the cooling rate should not be too fast, slow cooling is conducive to the full dissolution of aromatic compounds in the oil, thereby allowing aromatic compounds to separate completely from the coffee extract. In contrast, a rapid cooling speed can cause the coffee oil to solidify rapidly when encountering the cold, which does not allow enough time for aroma compounds to be dissolved by the oils, leaving the aroma compounds suspended in the solution (i.e., the coffee extract) and leading to loss of the aroma compounds during subsequent membrane filtration. Finally, the cooled second mixture is stored at a temperature of 0-8° C., and the cooled second mixture is left to stand overnight. In this step, the coffee extract cannot freeze. At the lower temperature (i.e., temperature of 0-8° C.), the separation and stratification of the coffee oil and the coffee extract are accelerated, which is beneficial to the effective separation of oil and water later.

In step 5, the coffee oil layer is separated from the coffee liquid layer, and thus the coffee liquid layer is obtained. The coffee liquid layer is filtered using a ceramic membrane to obtain a filtered coffee liquid layer, and the filtered coffee liquid layer is concentrated using a reverse osmosis membrane to obtain a concentrated coffee liquid layer with a mass concentration of 7%-30%, then the concentrated coffee liquid layer is uniformly mixed with the coffee oil layer to obtain a third mixture, and then the third mixture is degassed, nitrogen filled and packaged. In step 5, the coffee oil layer is separated from the coffee liquid layer, and the coffee liquid layer is collected, then is filtered by the ceramic membrane and finally is concentrated by the reverse osmosis membrane to obtain the concentrated coffee liquid layer with the mass concentration of 7%-30%. In the previous step (i.e., step 4), since aroma components are dissolved in the coffee oil, the aroma components are separated from the coffee extract, so that the membrane filtration and membrane concentration processes only need to be performed on the coffee extract without affecting the aroma components. The concentrated coffee liquid layer is uniformly mixed with the coffee oil layer to obtain a third mixture. Then the third mixture is degassed, nitrogen filled and packaged to obtain a packaged mixture. The difficulty in storing the coffee liquid is mainly due to the existence of oxygen in the environment or micro-environment of the coffee liquid. Degassing is an effective method to remove oxygen from the coffee liquid, and the degassing is usually carried out under vacuum conditions. Under vacuum conditions, except oxygen, other volatile elements (such as aroma) are easy to volatilize and cause losses. Due to the slow cooling treatment in the previous step 4, the aroma components are fully dissolved in the coffee oil, so that volatile elements such as flower and fruit fragrance are not easy to be lost in the negative pressure degassing process in the step 5, thereby achieving the effect of preserving aroma.

In step 5, before the packaging, a pH value of the third mixture may be adjusted, or the packaging is performed directly without changing the pH value, and the skilled in the art can select one from these two manners according to different coffee varieties.

In step 6, the packaged mixture (i.e., the packaged coffee liquid) is thermally sterilized in a water bath at a temperature of 60-100° C. for 20-60 minutes. Thus, the coffee concentrate with high retention of floral and fruity aromas is obtained. As the temperature for the water bath sterilization decreases, a sterilization time must be increased to ensure thorough sterilization; otherwise, shorter sterilization time may affect the aroma, the flavor, the acidity, and the body of the prepared coffee concentrate. For example, at the temperature for the water bath sterilization below 90° C.: when the temperature for the water bath sterilization is 85° C., a sterilization time should not be less than 35 minutes, which may be in a range of 35-60 minutes. Longer sterilization time (i.e., more than 35 minutes) is suitable, but shorter sterilization time (i.e., less than 35 minutes) is not suitable. At the temperature for the water bath sterilization of 90° C. or above 90° C., when the temperature for the water bath sterilization is 90° C., a sterilization time can be 30 minutes, which may be in a range of 30-45 minutes. If the sterilization time is more than 45 minutes (for example, 45-60 minutes), the coffee flavor will change.

In a second aspect, an embodiment of the present disclosure provides coffee concentrate, and the coffee concentrate is prepared using the method for preparing coffee concentrate described above.

In a third aspect, an embodiment of the present disclosure provides a method for retaining floral aroma components in coffee concentrate, which includes the method for preparing the coffee concentrate described above.

The present disclosure will be further illustrated by an embodiment 1 and comparative examples 1-8.

### Embodiment 1

This embodiment provides a method for preparing coffee concentrate, including steps 1-6.

In step 1, coffee beans are ground to obtain ground coffee beans with a particle size of 80 mesh.

In step 2, the ground coffee beans are added to water according to a solid-to-liquid ratio of 1:10 (g:mL), ultrasonic extraction is then performed for 40 minutes at a water temperature of 20° C. (i.e., a temperature of the water is 20° C.) to obtain a first mixture, and finally the first mixture is filtered to separate coffee extract from coffee grounds.

In step 3, ethanol with a volume concentration of 95% is added to the coffee grounds for extraction according to a solid-to-liquid ratio of 1:5 (g:mL), and a duration for the extraction is 30 minutes. Then, a concentrating process under reduced pressure is performed at a temperature of 40° C. to remove ethanol to obtain coffee oil.

In step 4, at normal temperature, the coffee oil is added to the coffee extract and uniformly mixed to obtain a second mixture. Then, the temperature of the second mixture is slowly lowered at a cooling rate of 5° C./h to reach a temperature in a range of 4° C., which is not allowed to freeze. Then, the second mixture is left to stand overnight until the coffee oil and extract are fully layered to obtain a coffee oil layer and a coffee liquid layer.

In step 5, the coffee oil layer is separated from the coffee liquid layer, and thus, the coffee liquid layer is obtained. The coffee liquid layer is filtered using a ceramic membrane to obtain filtered coffee liquid layer, and the filtered coffee liquid layer is concentrated using a reverse osmosis membrane to obtain a concentrated coffee liquid layer with a mass concentration of 9%, then the concentrated coffee liquid layer is uniformly mixed with the coffee oil layer to get a third mixture, and then the third mixture is degassed, nitrogen filled and packaged to receive a packaged mixture.

In step 6, the packaged mixture (i.e., the packaged coffee liquid) is thermally sterilized in a water bath at a temperature of 90° C. for 30 minutes. Thus, the coffee concentrate with high retention of floral and fruity aromas is obtained.

### Comparative Example 1

The only difference between the comparative example 1 and the embodiment 1 is that: in step 3 of the comparative example 1, ethanol with a volume concentration of 70% is used. The remaining steps and parameters in the comparative example 1 are the same as those in the embodiment 1.

### Comparative Example 2

The only difference between the comparative example 2 and the embodiment 1 is that: in step 6 of the comparative example 2, a temperature for the water bath sterilization of the comparative example 2 is 121° C. and a sterilization time of the comparative example 2 is 30 minutes. The remaining steps and parameters in the comparative example 2 are the same as those in the embodiment 1.

### Comparative Example 3

The only difference between the comparative example 3 and the embodiment 1 is that: in step 6 of the comparative example 3, a temperature for the water bath sterilization of the comparative example 3 is 80° C. and a sterilization time of the comparative example 3 is 20 minutes. The remaining steps and parameters in the comparative example 3 are the same as those in the embodiment 1.

### Comparative Example 4

Coffee beans are ground to obtain ground coffee beans with a particle size of 80 mesh, water is added to the ground coffee beans according to a ratio of powder to water of 1:12 (g:mL) to obtain a mixture, and the mixture is placed in a refrigerator at a temperature of 4° C. for 12 h for completing a soaking and extraction process of the ground coffee beans, and then a filtrate is obtained by a filtration process, which is cold-brewed coffee original liquid.

### Comparative Example 5 (Membrane Concentrate)

The only difference between the comparative example 5 and the embodiment 1 is that: step 4 is omitted in the comparative example 5. In step 5 in the comparative example 5, the coffee extract is directly filtered using a ceramic membrane and then is concentrated using a reverse osmosis membrane to obtain concentrated coffee extract with a mass concentration of 9%. The concentrated coffee extract is uniformly mixed with the coffee oil to get a mixture, and then the mixture is degassed, nitrogen filled and packaged. The remaining steps and parameters in the comparative example 5 are the same as those in the embodiment 1.

### Comparative Example 6

The only difference between the comparative example 6 and the embodiment 1 is that: a cooling method in step 4 of the comparative example 6 is a natural cooling step of standing at room temperature. The remaining steps and parameters in the comparative example 6 are the same as those in the embodiment 1.

### Comparative Example 7

The only difference between the comparative example 7 and the embodiment 1 is that: a cooling method in step 4 of the comparative example 7 is rapidly cooling at −40° C. (the technical effect thereof is equivalent to a technical effect under a temperature in a range from −80° C. to −40° C.). The remaining steps and parameters in the comparative example 7 are the same as those in the embodiment 1.

### Comparative Example 8

The only difference between the comparative example 8 and the embodiment 1 is that: step 3 is omitted in the comparative example 8. In step 4 of the comparative example 8, the coffee extract is slowly cooled at room temperature at a cooling rate of 3-5° C./h, and is finally cooled to a temperature of 4° C., which is not allowed to freeze. Then, the cooled coffee extract is left to stand overnight until the coffee oil and the coffee extract are fully layered to obtain a coffee oil layer and a coffee liquid layer (that is, the coffee extract is directly cooled in step 4 of the comparative example 8, and the addition of the coffee oil is omitted). The remaining steps and parameters in the comparative example 8 are the same as those in the embodiment 1.

Sensory evaluation is conducted on the cold-brewed coffee original liquid and coffee concentrate prepared in the embodiment one and the comparative examples 1-8 (in the comparative example 4, the flavor of cold-brewed coffee original liquid is evaluated directly after preparation, while the flavor evaluation in the embodiment one and comparative examples 1-3 and 5-8 is assessed after the prepared coffee concentrate samples are stored for one month).

A sensory evaluation team consists of 10 people (five males and five females), all of whom are quality grading tasters (Q-Graders) of specialty coffee, and can accurately identify the quality of coffee. Sensory evaluation is carried out according to a sensory evaluation standard formulated by American Fine Coffee Association (SCA), and indexes such as aroma, flavor, acidity, body, uniformity, clean cup, balance and sweetness are selected for evaluation. All samples are provided at room temperature of 20° C. and evaluated randomly.

Each treatment is repeated five times independently, and samples are taken for evaluation by the tasters. The tasters use a 0-10 scale to evaluate the intensity of attributes, with an increment of 0.25 scores (0=none; 10=extremely intense). The results are as follows.

### 1. Aroma Description

Aroma description corresponding to the embodiment 1 is as follows: aroma: white floral, citrus, berries, with a honey undertone; flavor: ripe citrus, berries, red berries, with juicy sensation; and aftertaste: medium to long, with distinct sweetness, bright acidity, relatively balanced acidity and bitterness, and a smooth texture.

Aroma description corresponding to the comparative example 1 (extracted with 70% ethanol) is as follows: heavy astringency and pronounced smoky notes, with a short aftertaste and fewer positive flavors.

Aroma description corresponding to the comparative example 2 (sterilized at 121° C. for 30 minutes) is as follows: sharp and stimulating acidity, with reduced body.

Aroma description corresponding to the comparative example 3 (insufficient sterilization) is as follows: defective sourness, with a pronounced off-flavor and sourness reminiscent of rotten fruit.

Aroma description corresponding to the comparative example 4 (cold-brewed coffee original liquid) is as follows: main notes of white floral and citrus, with a hint of berries and a honey undertone; flavor: ripe citrus, sweet orange, with a hint of berries and red berries, and a juicy sensation; Juicy sensation; and aftertaste: medium to long, with distinct sweetness, bright acidity, relatively balanced acidity and bitterness, and a soft, smooth texture.

The aroma description corresponding to the comparative example 5 (membrane concentrated solution) is as follows: slight citrus flavor; weak juicy sensation; and aftertaste: medium to long, with distinct sweetness, changing acidity, relatively balanced acidity and bitterness, and a smooth texture.

### 2. Flavor

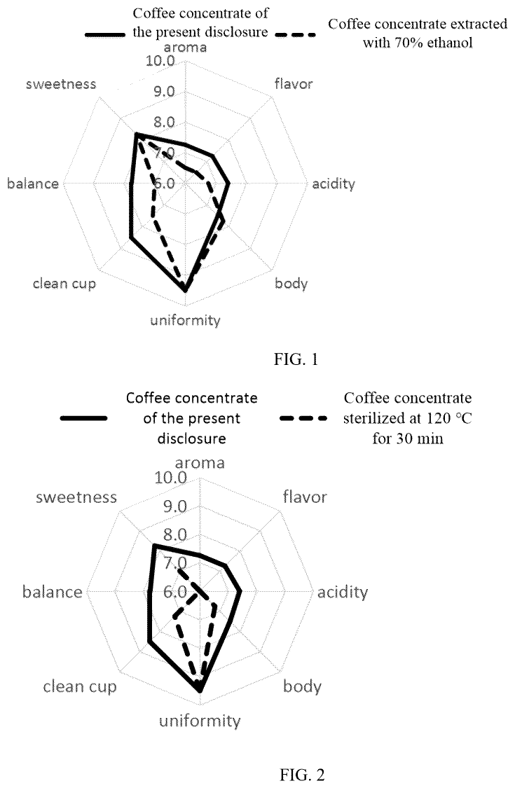

FIG. 1 shows flavor retention conditions of the coffee concentrates prepared in the embodiment 1 and the comparative example 1 (in FIG. 1, the coffee concentrate of the present disclosure corresponds to the embodiment 1, and the coffee concentrate extracted with 70% ethanol corresponds to the comparative example 1).

FIG. 2 shows flavor retention conditions of the coffee concentrates prepared in the embodiment 1 and the comparative example 2 (in the FIG. 2, the coffee concentrate of the present disclosure corresponds to the embodiment 1, and the coffee concentrate sterilized at 120° C. for 30 minutes corresponds to the comparative example 1).

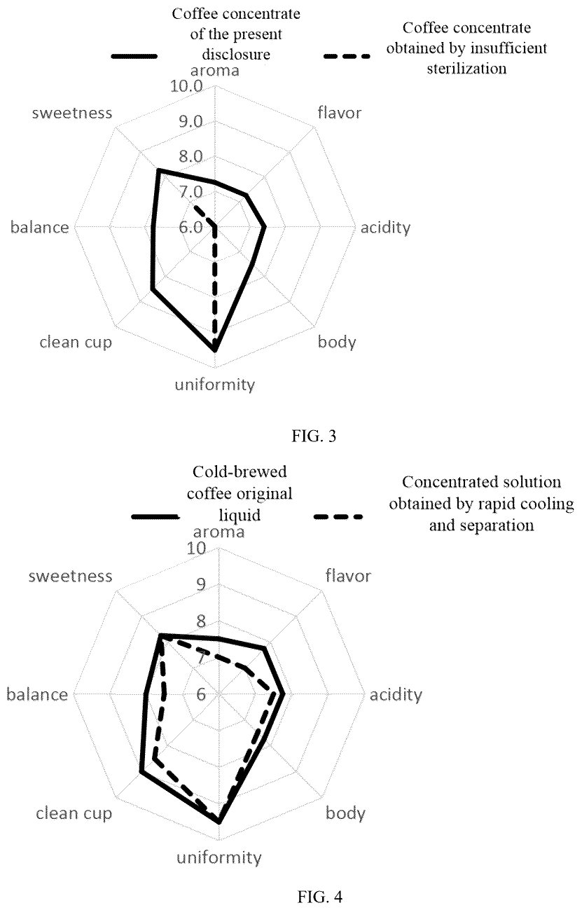

FIG. 3 shows flavor retention conditions of the coffee concentrates prepared in the embodiment 1 and the comparative example 3 (in FIG. 3, the coffee concentrate of the present disclosure corresponds to the embodiment 1, and the coffee concentrate obtained by insufficient sterilization corresponds to the comparative example 3).

FIG. 4 shows flavor retention conditions of the cold-brewed coffee original liquid prepared in the comparative example 4 and the coffee concentrate prepared in the comparative example 7 (in FIG. 4, the cold-brewed coffee original liquid corresponds to the comparative example 4, and the concentrated solution obtained by rapid cooling and separation corresponds to the comparative example 7).

FIG. 5 shows flavor retention conditions of the cold-brewed coffee original liquid prepared in the comparative example 4 and the coffee concentrate prepared in the comparative example 6 (in FIG. 5, the cold-brewed coffee original liquid corresponds to the comparative example 4, and the concentrated solution obtained by slow cooling without stirring corresponds to the comparative example 6).

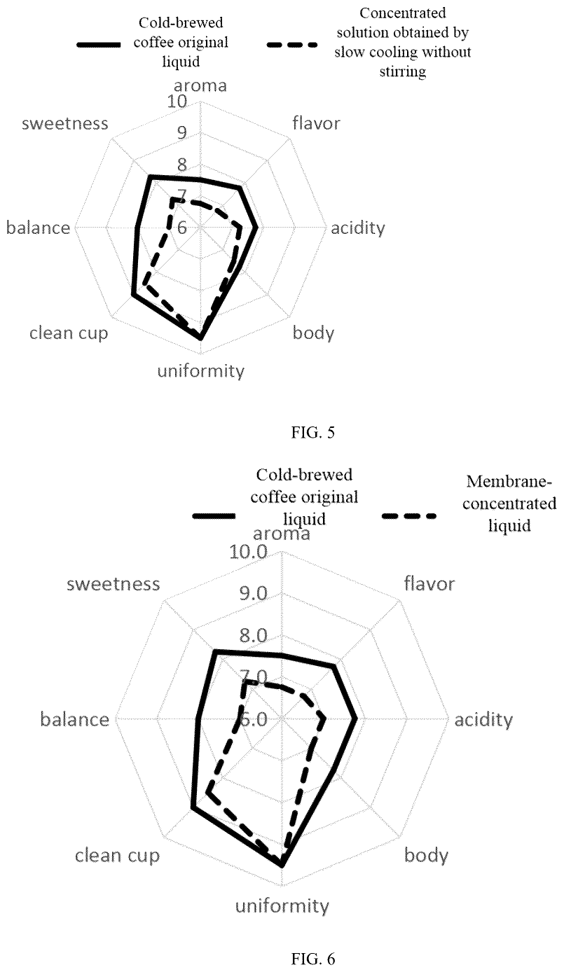

FIG. 6 shows flavor retention conditions of the cold-brewed coffee original liquid prepared in the comparative example 4 and the coffee concentrate prepared in the comparative example 5 (in FIG. 6, the cold-brewed coffee original liquid corresponds to the comparative example 4, and the membrane-concentrated liquid corresponds to the comparative example 5).

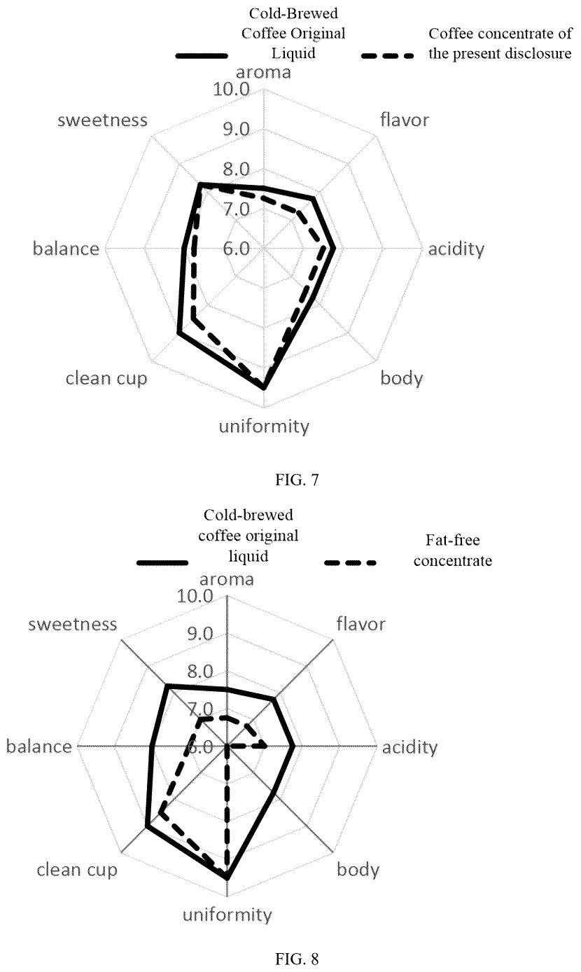

FIG. 7 shows flavor retention conditions of cold-brewed coffee original liquid prepared in the comparative example 4 and coffee concentrate prepared in the embodiment 1 (in FIG. 7, the cold-brewed coffee original liquid corresponds to the comparative example 4, and the coffee concentrate of the present disclosure corresponds to the embodiment 1).

FIG. 8 shows flavor retention conditions of the cold-brewed coffee original liquid prepared in the comparative example 4 and coffee concentrate prepared in the comparative example 8 (in FIG. 8, the cold-brewed coffee original liquid corresponds to the comparative example 4, and the fat-free concentrate corresponds to the comparative example 8).

Table 1 shows results of flavor indexes of the coffee concentrates and the cold-brewed coffee original liquids prepared in the embodiment 1 and the comparative examples 1-8.

TABLE 1

| | | | | | | Clean | | |
|---|---|---|---|---|---|---|---|---|
| | Aroma | Flavor | Acidity | Body | Uniformity | cup | Balance | Sweetness |
| Embodiment | 7.25 | 7.25 | 7.5 | 7.5 | 9.5 | 8.5 | 7.75 | 8.25 |
| 1 | | | | | | | | |
| Comparative | 6.5 | 6.5 | 6.75 | 7.75 | 9.5 | 7.5 | 7 | 8.25 |
| Example 1 | | | | | | | | |
| Comparative | 6 | 6 | 6 | 6.75 | 9.5 | 7.25 | 6 | 7 |
| Example 2 | | | | | | | | |
| Comparative | 6 | 6 | 6 | 6 | 9.5 | 6 | 6 | 6.75 |
| Example 3 | | | | | | | | |
| Comparative | 7.5 | 7.75 | 7.75 | 7.75 | 9.5 | 9 | 8 | 8.25 |
| Example 4 | | | | | | | | |
| Comparative | 6.75 | 6.75 | 7 | 7 | 9.5 | 8.5 | 7 | 7.25 |
| Example 5 | | | | | | | | |
| Comparative | 6.75 | 6.75 | 7.25 | 7.5 | 9.5 | 8.5 | 7 | 7.25 |
| Example 6 | | | | | | | | |
| Comparative | 7 | 7 | 7.5 | 7.5 | 9.5 | 8.5 | 7.5 | 8.25 |
| Example 7 | | | | | | | | |
| Comparative | 6.75 | 6.75 | 7 | 6 | 9.5 | 8.5 | 7 | 7 |
| Example 8 | | | | | | | | |

The above-mentioned embodiments only describe the exemplary embodiments of the present disclosure, and do not limit the scope of the present disclosure. Under the premise of not departing from the design spirit of the present disclosure, various modifications and improvements made by ordinary technicians in the field to the technical scheme of the present disclosure shall fall within the scope of protection determined by the claims of the present disclosure.

1. A method for preparing coffee concentrate, comprising the following steps implemented sequentially in the following order:
grinding coffee beans to obtain ground coffee beans, adding the ground coffee beans to water and then performing ultrasonic extraction at a temperature of 0-30° C. for 10-60 minutes to obtain a first mixture, and filtering the first mixture to obtain coffee extract and coffee grounds;
adding the coffee grounds into ethanol aqueous solution with a volume concentration of 80%-95% for extraction, and then removing ethanol by vacuum concentration to obtain coffee oil;
uniformly mixing the coffee oil and the coffee extract at room temperature to make the coffee oil be in contact with aroma components in the coffee extract, and make aroma components dissolve in the coffee oil to thereby obtain a second mixture, and cooling the second mixture to 0-8° C. at a cooling rate of 3-5° C./h and then standing the second mixture for 8-12 hours to obtain a coffee oil layer and a coffee liquid layer;
filtering the coffee liquid layer using a ceramic membrane to obtain a filtered coffee liquid layer, and concentrating the filtered coffee liquid layer using a reverse osmosis membrane to obtain a concentrated coffee liquid layer with a mass concentration of 7%-30%; and
uniformly mixing the concentrated coffee liquid layer with the coffee oil layer to obtain a third mixture, performing degassing, nitrogen filling and packaging on the third mixture to obtain a packaged mixture, and performing water bath sterilization on the packaged mixture to thereby obtain the coffee concentrate, wherein the water bath sterilization is performed under a temperature of 60-85° C. for a duration of 35-60 minutes, or under a temperature of 90-100° C. for 35-45 minutes.

2. The method for preparing coffee concentrate as claimed in claim 1, wherein a temperature for the vacuum concentration is 30-60° C.

3. Coffee concentrate, wherein the coffee concentrate is prepared using the method for preparing the coffee concentrate as claimed in claim 1.

4. A method for retaining floral aroma components in coffee concentrate, comprising the method for preparing the coffee concentrate as claimed in claim 1.
